(19) United States
(12) Patent Application Publication
(10) Pub. No.: US 2002/0105718 A1
(43) Pub. Date: Aug. 8, 2002

(54) Optoelectronic device having a diffraction grating associated therewith and a method of manufacture therefor

(75) Inventors: Kenneth L. Bacher, Macungie, PA (US); William C. Dautremont-Smith, Orefield, PA (US); Jin Feng, Allentown, PA (US)

Correspondence Address: HITT GAINES & BOISBRUN P.C., P.O. BOX 832570, RICHARDSON, TX, 75083, US

(73) Assignee: Agere Systems Inc., Allentown, PA (US)

(21) Appl. No.: 10/062,221

(22) Filed: Oct. 26, 2001

Related U.S. Application Data
(63) Continuation-in-part of application No. 09/769,083, filed on Jan. 25, 2001, now Pat. No. 6,384,963.

(51) Int. Cl. H01S 3/00

(52) U.S. Cl. 359/334

(57) ABSTRACT

The present invention provides an optoelectronic device, a method of manufacture therefor and an optical communications system including the same. In an exemplary embodiment, the optoelectronic device includes a device body including an active region having a cavity length defined by a back facet and a front facet. The optoelectronic device may further include a diffraction grating optically coupled to the active region, wherein the diffraction grating has a grating length of less than about 25 percent of the cavity length.

### CROSS-REFERENCE TO RELATED APPLICATION

This application is a continuation in part of U.S. patent application Ser. No. 09/769,083, filed on Jan. 25, 2001, entitled “OPTICAL COMMUNICATION SYSTEM WITH COPROPAGATING PUMP RADIATION FOR RAMAN AMPLIFICATION” to David Ackerman, et al., which is incorporated herein by reference.

### TECHNICAL FIELD OF THE INVENTION

The present invention is directed, in general, to an optoelectronic device and, more specifically, to an optoelectronic device having a diffraction grating associated therewith, a method of manufacture therefor, and an optical communications system including the same.

### BACKGROUND OF THE INVENTION

Optoelectronic devices, such as lasers for use in optical communication systems, have to meet very stringent requirements. More specifically, Distributed Feedback (DFB), Distributed Bragg Reflector (DBR), and Fiber Bragg Grating (FBG) lasers used in Raman applications, have very stringent requirements. Typically, it is desirable for the DFB, DBR, or FBG lasers to have high output power (120 mW-300 mW), wavelength stabilization (within +/−1.5 nm), high Stimulated Brillouin Scattering (SBS), threshold (greater than about 300 mW), and low cost. Additionally, for Raman applications where the pumps propagate in the same direction as the signal (co-propagating), low relative intensity noise (less than about −145 dB/Hz), is also desired.

Currently, there are limited types of lasers that provide all of the above-listed properties while being compatible with Raman applications. Diffraction gratings have been known to be used to achieve wavelength stabilization. For example, diffraction gratings may be integrated either into a laser structure as in DFB and DBR devices, or in a fiber pigtail in the case of FBG stabilized lasers. A problem exists in that each of the approaches is deficient in at least one of the above-listed properties.

For example, FBG lasers can meet the power and spectral requirements listed above, however, the long external cavity associated with such devices increases the relative intensity noise to about −125 dB/Hz. This is generally undesirable, because it makes such systems unsuitable for co-propagating Raman applications. Additionally, the attachment of an external diffraction grating also adds to the cost and manufacturing complexity of the pump module.

Conventional DFB and DBR lasers, on the other hand, have a very narrow linewidth, which typically limits the launch power to less than 10 mW, before SBS effects become significant. This linewidth may be broadened by applying an AC dither to the DC bias, however, this adds considerable complexity to the drive circuitry and, especially in the case of DFB lasers, introduces intensity modulation to the output.

Accordingly, what is needed in the art is an optoelectronic device that does not experience the drawbacks encountered by the conventional devices listed above. Also needed, is an optoelectronic device that is compatible with Raman applications, that does not experience the drawbacks encountered by the conventional devices listed above.

### SUMMARY OF THE INVENTION

To address the above-discussed deficiencies of the prior art, the present invention provides an optoelectronic device, a method of manufacture therefor, and an optical communications system including the same. In an exemplary embodiment, the optoelectronic device includes a device body including an active region having a cavity length defined by a back facet and a front facet. The optoelectronic device may further include a diffraction grating optically coupled to the active region, wherein the diffraction grating has a grating length of less than about 25 percent of the cavity length.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a cross-sectional view of an optoelectronic device, which has been constructed in accordance with the principles of the present invention;

FIG. 2 illustrates a cross-sectional view of a partially completed optoelectronic device, which is in accordance with the principles of the present invention;

FIG. 3 illustrates a cross-sectional view of the partially completed optoelectronic device illustrated in FIG. 2, after formation of a diffraction grating from a grating layer structure;

FIG. 4 illustrates a cross-sectional view of the partially completed optoelectronic device shown in FIG. 3, after formation of a spacer layer over the diffraction grating;

FIG. 5 illustrates a cross-sectional view of the partially completed optoelectronic device shown in FIG. 4, after formation of a lower confinement layer in accordance with the principles of the present invention;

FIG. 6 illustrates a cross-sectional view of the partially completed optoelectronic device illustrated in FIG. 5, after formation of a conventional radiation cavity in accordance with the principles of the present invention;

FIG. 7 illustrates a cross-sectional view of the partially completed optoelectronic device shown in FIG. 6, after formation of an upper cladding layer over the active region;

FIG. 8 illustrates a graphical representation of a Prior Art laser structure and a graphical representation of the optoelectronic device illustrated in FIG. 1;

FIG. 9 illustrates an optical communication system, which may form one environment where an optoelectronic device, similar to the optoelectronic device shown in FIG. 1, may be included; and

FIG. 10 illustrates an alternative optical communication system.

### DETAILED DESCRIPTION

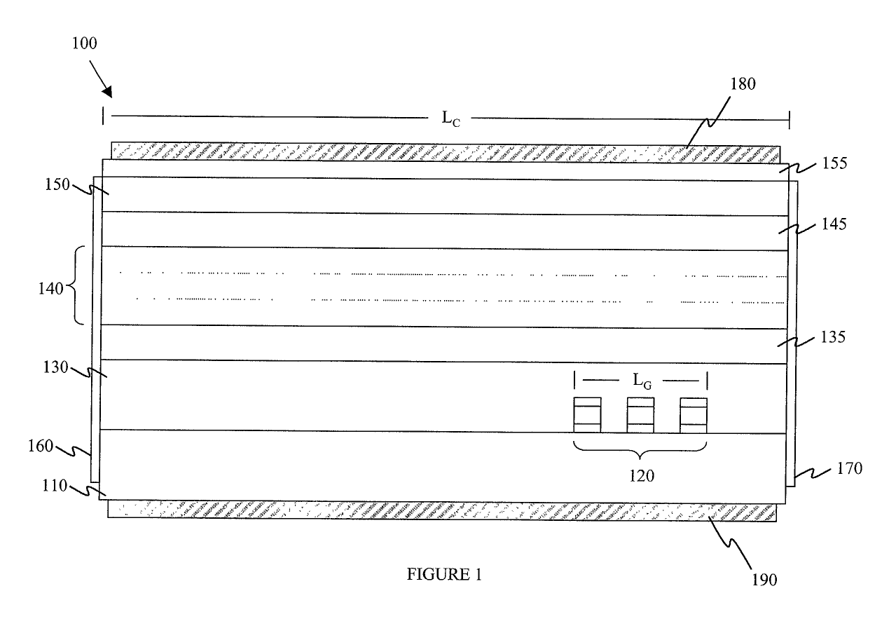

Referring initially to FIG. 1, illustrated is a cross-sectional view of an optoelectronic device 100, which has been constructed in accordance with the principles of the present invention. It should initially be pointed out that the cross-sectional view of the optoelectronic device depicted in FIGS. 1-7 is along a length of the optoelectronic device. As such, radiation traversing through the optoelectronic device 100 illustrated in FIG. 1, would typically move from right to left and from left to right across the page, as compared to into the page if a different cross-sectional view were shown.

The present invention is directed to an optoelectronic device 100 made of any material or compound that may have use in such devices. In the illustrative embodiments described herein, the optoelectronic device 100 is specifically discussed as a group III-V based device, for example an indium phosphide/indium gallium arsenide phosphide (InP/InGaAsP) based device, a gallium arsenide (GaAs) based device, an aluminum gallium arsenide (AlGaAs) based device, or another group III-V based device. Even though the present invention is discussed in the context of a group III-V based device, it should be understood that the present invention is not limited to group III-V compounds and that other compounds located outside groups III-V may be used.

In the illustrative embodiment shown in FIG. 1, the optoelectronic device 100 includes an optoelectronic substrate 110 having a diffraction grating 120 located thereover. As illustrated, the diffraction grating 120 has a length (L_{G}). The diffraction grating 120 may further include a kL_{G} value ranging from about 0.06 to about 1.0, and more preferably from about 0.06 to about 0.35, and even more preferably from about 0.07 to about 0.14, wherein k is a grating coupling constant of the diffraction grating. Located over the diffraction grating 120, in the embodiment shown in FIG. 1, is a spacer layer 130. The spacer layer 130 may be specifically tailored to provide a particular reflectivity for the diffraction grating 120.

As illustrated, located over the spacer layer 130 may be a lower confinement layer 135. Additionally, located over the lower confinement layer 135 may be an active region 140, such as an active region of a Distributed Feedback (DFB) or Distributed Bragg Reflector (DBR) laser. In the particular embodiment shown in FIG. 1, the active region 140 comprises a number of quantum well regions, however, any type of radiation cavity 140 is within the scope of the present invention. While it has been shown that the active region 140 is formed over the diffraction grating 120, it should be noted that the diffraction grating 120 may be formed over the active region 140 without departing from the scope of the present invention. Formed over the active region 140, in the illustrative embodiment shown in FIG. 1, is an upper confinement layer 145, an upper cladding layer 150, and a capping layer 155. A radiation cavity formed by the active region 140, upper and lower confinement layers 135, 145, upper cladding layer 150, and substrate layers 110, 120, 130, as shown, has a cavity length (L_{c}).

Located on a back facet of the optoelectronic device 100 is a back facet coating 160. In an exemplary embodiment, the back facet coating 160 is a conventional high reflection (HR) coating. Located on a front facet of the optoelectronic device 100 is a conventional front facet coating 170. In contrast to the back facet coating 160, the front facet coating 170 may be an antireflection (AR) coating. It should be noted that in most situations, the front facet is the facet from which the majority of the radiation is emitted. While the present invention has been briefly discussed as having the HR coating on the back facet and the AR coating on the front facet, it should be noted that these may be interchanged. The embodiment of the optoelectronic device 100 illustrated in FIG. 1, further includes a conventional upper contact 180 and a conventional lower contact 190.

It has been unexpectedly found that using a diffraction grating having a grating length (L_{G}) of less than about 25% of the cavity length (L_{c}), provides superior results over those achieved in prior art devices, as explained below. As such, in the illustrative embodiment shown in FIG. 1, the grating length (L_{G}) is less than about 25% of the cavity length (L_{c}). Alternatively, the grating length (L_{G}) may be less than about 15% of the cavity length (L_{c}), and more preferably, less than about 9%, or alternatively, less than about 4%.

The reduced length of the grating (L_{G}) provides certain benefits that were not provided by the prior art devices. For instance, the reduced length of the grating (L_{G}) causes a bandwidth of the grating reflectivity to be significantly wider than the cavity mode spacing. This allows multiple cavity modes near the peak reflectivity of the grating to laze simultaneously, and results in a broadened linewidth, which suppresses Stimulated Brillouin Scattering (SBS) effects. In one example, a grating length (L_{G}) of about 75 μm and a cavity length (L_{c}) of about 1.3 mm provides a Full Width Half Maximum (FWHM) of the grating reflectivity that exceeds about 4 nm, while the cavity mode spacing is about 0.25 nm. Typically, an RMS spectral width of about 0.2 nm (at about 25 GHz) may be achieved for this device relative to a linewidth of less than about 1 MHz for a standard DFB. Additionally, the present invention provides a reduced side mode suppression ratio (SMSR). In an exemplary embodiment the SMSR is less than about 10 dB.

It was also unexpectedly found that increasing the number of mode lasing by a small number would dramatically reduce the SBS effects. This is contrary to that understood by those skilled in the art. For example, those skilled in the art would generally understand that the SBS threshold would only increase proportionally to the number of modes, therefore, providing a smaller SBS threshold value of between about 30 mW and about 60 mW. The present invention, contrary to what would be expected by those skilled in the art, may achieve SBS threshold values of greater than about 75 mW, and more importantly, SBS threshold values of greater than about 200 mW. The larger SBS threshold values are obtained in part, from the larger emission spectrum obtainable by the present invention.

Additionally, wavelength stabilization may be obtained using the diffraction grating, without the cost and complexity of an external Fiber Bragg Grating (FBG). Moreover, relative intensity noise performance of better than about −150 dB/Hz may be obtained, which is significantly higher than that of conventional FBG lasers, and somewhat approaching that of conventional Distributed Feedback (DFB) lasers.

Other benefits that may be realized by the optoelectronic device 100 include precise control of the output reflectivity. The precise control of the output reflectivity may be obtained by well controlled epitaxial growth of the spacer layer 130 and photolithography of the grating length (L_{G}). The precise control of the output reflectivity may further provide substantially optimized output power.

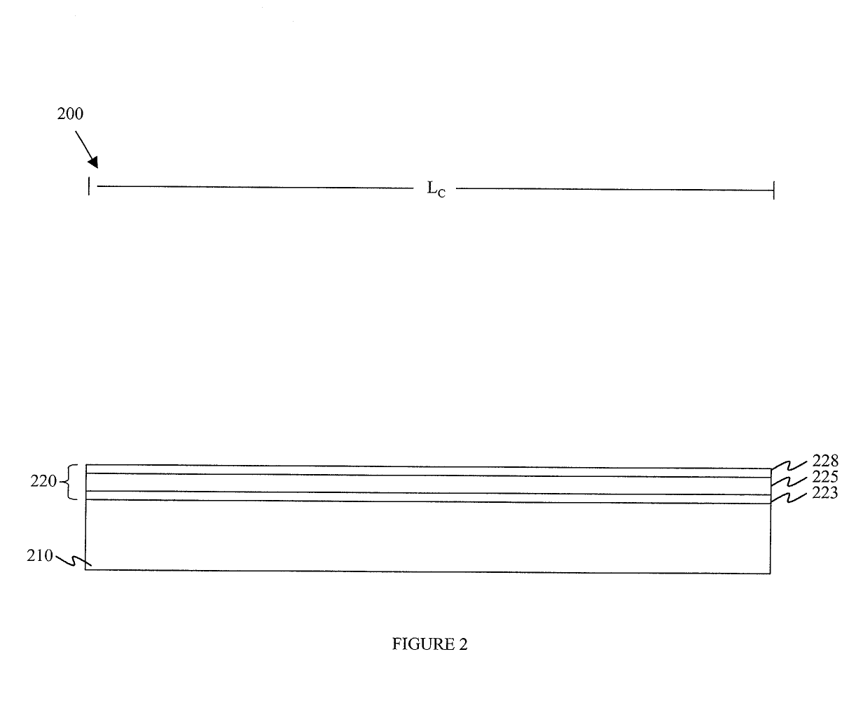

Turning now to FIGS. 2-7, illustrated are cross-sectional views of detailed manufacturing steps illustrating how an exemplary embodiment of an optoelectronic device, similar to the optoelectronic device 100 illustrated in FIG. 1, may be manufactured. FIG. 2 illustrates a cross-sectional view of a partially completed optoelectronic device 200, which is in accordance with the principles of the present invention. The partially completed optoelectronic device 200 includes an optoelectronic substrate 210. The optoelectronic substrate 210 may be any layer located in an optoelectronic device, including a layer located at a wafer level or a layer located above or below the wafer level. The optoelectronic substrate 210, in an exemplary embodiment, is an n-type doped indium phosphide (InP) substrate. The n-type dopant may comprise various elements, however, in an exemplary embodiment the n-type dopant comprises silicon. Other optoelectronic substrates 210, however, are within the scope of the present invention.

Formed over the optoelectronic substrate 210 in the particular embodiment illustrated in FIG. 2, is a diffraction grating layer structure 220. The diffraction grating layer structure 220 may, in an alternative embodiment, comprise multiple layers. For example, in the illustrative embodiment shown in FIG. 2, the diffraction grating layer structure 220 comprises a first grating layer 223 comprising InP, a second grating layer 225 comprising a quaternary material such as InGaAsP, and a third grating layer 228 comprising InP. The optoelectronic substrate 210, and first, second and third grating layers 223, 225, 228, respectively, may be formed using various conventional processes. For example, in one embodiment, they may be formed using a conventional epitaxial process, such as a metalorganic vapor-phase epitaxy, or other similar process.

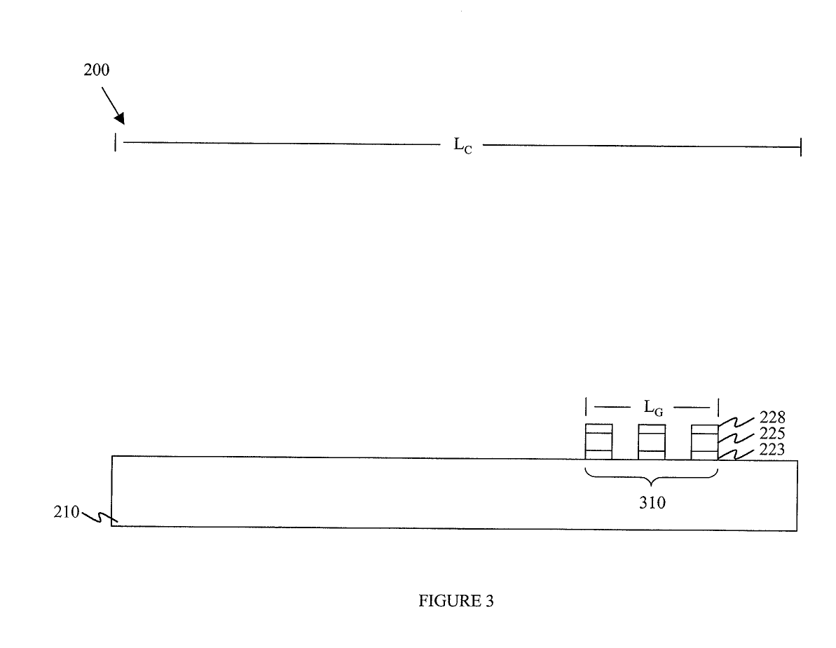

Turning now to FIG. 3, illustrated is a cross-sectional view of the partially completed optoelectronic device 200 illustrated in FIG. 2, after formation of a diffraction grating 310 from the grating layer structure 220. In the illustrative embodiment shown in FIG. 3, the diffraction grating 310 has a grating length (L_{G}) that is just long enough to control a wavelength of the optoelectronic device 200. For example, in an exemplary embodiment, the grating length (L_{G}) is less than about 25% of a cavity length (L_{c}) In an alternative embodiment, however, the grating length (L_{G}) is less than about 15% of the cavity length (L_{c}), and more preferably, and more preferably, less than about 9%, or alternatively, less than about 4%. In as much, one example provides a cavity length (L_{c}) of greater than about 1.3 mm and a grating length (L_{G}) ranging from about 50 μm to about 150 μm. While specific ratios and lengths have been given comparing the grating length (L_{G}) and cavity length (L_{c}), it should be noted that all ratios and lengths that provide an optimal stabilized mode, are within the scope of the present invention.

The diffraction grating 310 may be fabricated using various conventional processes. In an exemplary embodiment, however, the diffraction grating 310 is fabricated using a two step photolithographic process. In a first step a selective grating mask is used to expose photoresist over areas of grating layer structure 220 where the grating is not desired. Subsequently, a holographic grating exposure across the entire surface of grating layer structure 220 is performed. When the photoresist is developed, the grating pattern only exists in the areas protected by the selective grating mask in the first step. Thus, when the photoresist is developed and the grating layer structure 220 is etched, the diffraction grating 310 is formed.

Precise control of the front facet reflectivity may be realized by the aforementioned diffraction grating. In one instance, a thickness of the second grating layer 225 may be optimized to provide a specific diffraction grating 310 depth, and therefore an improved front facet reflectivity. In an another instance, the previously described manufacturing process allows the diffraction grating length (L_{G}) to be optimized, also providing an improved front facet reflectivity control. In a third instance, the thickness of the spacer layer may be optimized, also providing an improved front facet reflectivity control.

In an advantageous embodiment of the present invention, the optical period of the grating is varied along the cavity length to obtain more optimum reflectivity spectrum of the grating. This can be accomplished by varying either the physical period grating (e.g., a “chirped” grating) or average effective index of refraction in the grating region of the cavity. For example, a variation of the grating period in the range of about 0.02% to about 0.2% along its length can provide for a substantially “flatter” reflectivity peak for a given reflectivity bandwidth. The same effect can be achieved with a constant physical grating period by varying the lateral dimension of the waveguide, for example changing the mesa width from about 2.4 μm to about 2.7 μm, in the grating region. This embodiment can allow one skilled in the art to separately control the stability of the wavelength and the side mode suppression ratio, preferably to minimize the side mode suppression ratio while maintaining tight control of the lasing wavelength.

In an advantageous embodiment of the present invention, the diffraction grating 310 is located proximate the front facet. For example, in an exemplary embodiment, the diffraction grating 310 is offset from the front facet by a distance ranging from about 10 μm to about 40 μm. This offset, advantageously allows for errors in a subsequent cleaving process, without substantially reducing the already minimized diffraction grating length (L_{G}). It should be noted, however, other embodiments exists. For example, the diffraction grating 310 may be located at or near the back facet. In such an embodiment, a low reflection coating could be used over the front facet.

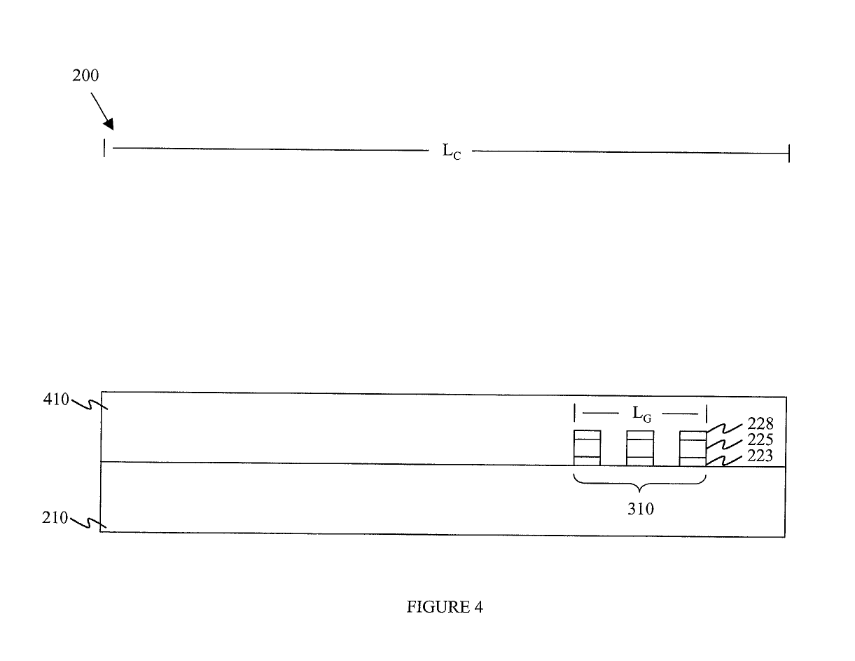

Turning now to FIG. 4, illustrated is a cross-sectional view of the partially completed optoelectronic device 200 shown in FIG. 3, after formation of a spacer layer 410 over the diffraction grating 310 and in the areas where the grating layer structure 220 has been completely removed. As illustrated, the spacer layer 410 may also be located between individual teeth of the diffraction grating 310. In the illustrative embodiment shown in FIG. 4, the spacer layer 410 comprises n-type doped InP. It should be understood, however, that the spacer layer 410 is not limited to n-type doped InP, and that other materials, doped or undoped, may be used.

The spacer layer 410 may be fabricated using various well-known processes. For example, in one embodiment, the spacer layer 410 may be formed using a conventional epitaxial process, such as a metalorganic vapor-phase epitaxy, or other similar process. Additionally, in one advantageous embodiment, the spacer layer 410 may be fabricated to a thickness ranging from about 0.15 μm to about 1 μm. The thickness is generally dependent on a desired strength of a reflectivity associated with the diffraction grating 310, thus, a wide range of thicknesses are within the scope of the present invention. In one exemplary embodiment, the optoelectronic substrate 210, the diffraction grating 310, and the spacer layer 410 form a lower cladding layer for the optoelectronic device 200.

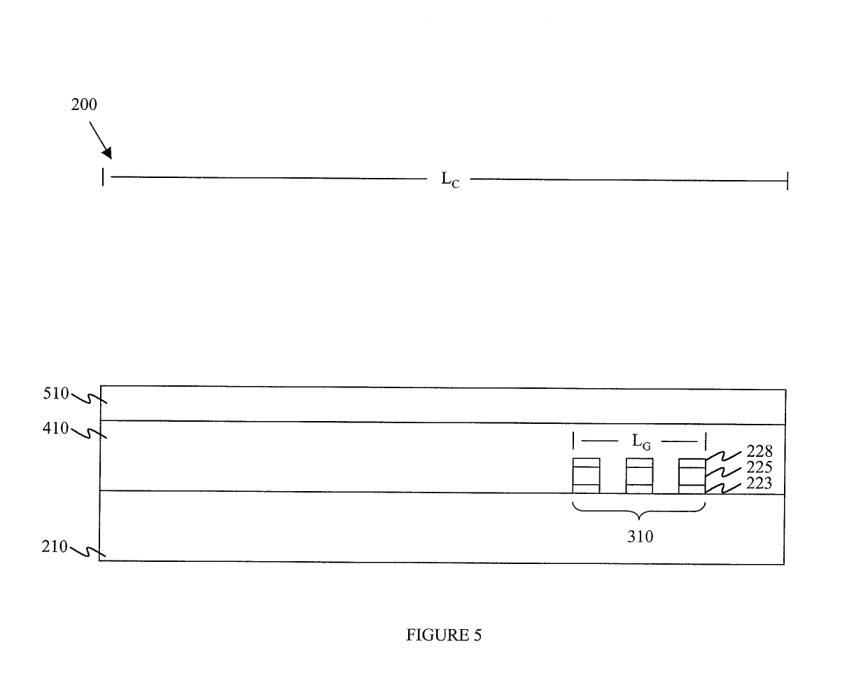

Turning to FIG. 5, illustrated is a cross-sectional view of the partially completed optoelectronic device 200 shown in FIG. 4, after formation of a lower confinement layer 510 in accordance with the principles of the present invention. The lower confinement layer 510, in an exemplary embodiment, is a conventional undoped InGaAsP confinement layer. It should be noted, however, that the lower confinement layer 510 is not limited to an undoped InGaAsP layer, and that other materials, doped or undoped, may be used. For example, in one particular embodiment, the lower confinement layer 510 comprises two different lower confinement layers having varying compositions of InGaAsP.

The lower confinement layer 510 may be formed using many know fabrication processes. For example, in one embodiment, the lower confinement layer 510 may be formed using a conventional epitaxial process, such as a metalorganic vapor-phase epitaxy, or other similar process.

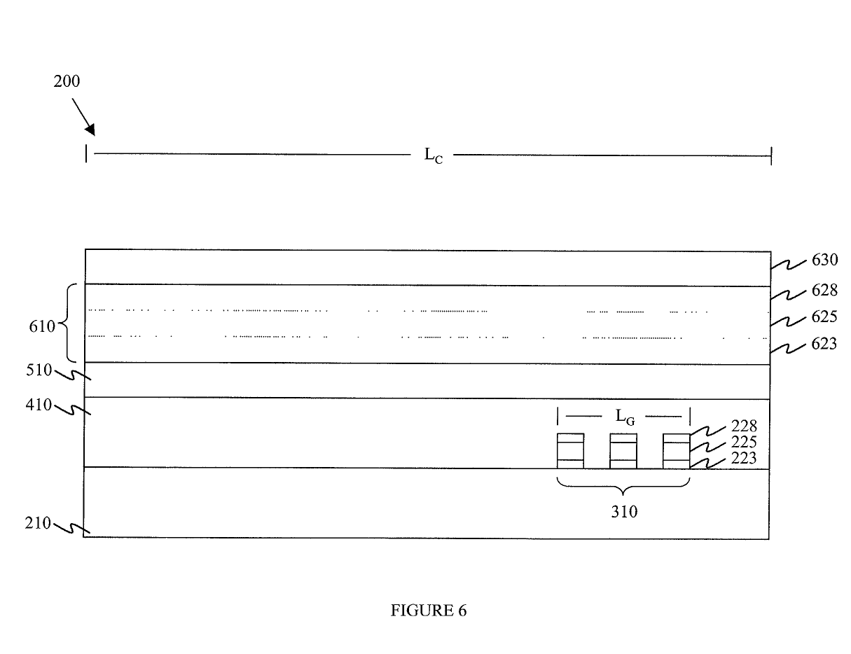

Turning now to FIG. 6, shown in a cross-sectional view of the partially completed optoelectronic device 200 illustrated in FIG. 5, after formation of a conventional radiation cavity 610 in accordance with the principles of the present invention. The active region 610, as previously mentioned during the discussion of FIG. 1, may comprise a number of quantum well regions 623, 625, 628. While three quantum well regions 623, 635, 628 have been illustrated, it should be noted that more or fewer than three quantum well regions are within the scope of the present invention.

The active region 610 may be formed using a variety of processes. For example, in one embodiment, the active region 610 may be formed using a conventional epitaxial process, such as a metalorganic vapor-phase epitaxy, or other similar process. In an exemplary embodiment of the invention, the active region 610 includes materials chosen from group III-V compounds. The active region 610 is typically intentionally not doped, however, in an alternative embodiment it may be doped as long as a p-n junction placement is taken into consideration.

Formed over the active region 610 may be an upper confinement layer 630. The upper confinement layer 630, in an exemplary embodiment, is a conventional p-type doped InGaAsP confinement layer. It should be noted, however, that the upper confinement layer 630 is not limited to a p-type doped InGaAsP layer, and that other materials, doped or undoped, may be used. For example, in one particular embodiment, the upper confinement layer 630 comprises two different upper confinement layers having varying compositions of InGaAsP.

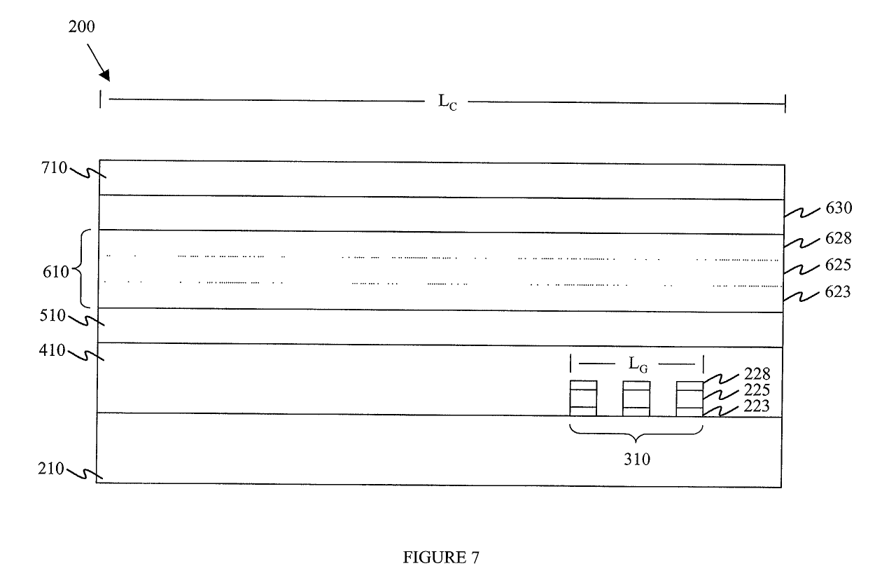

Turning to FIG. 7, illustrated is a cross-sectional view of the partially completed optoelectronic device 200 shown in FIG. 6, after formation of an upper cladding layer 710 over the active region 610 and upper confinement layer 630. The upper cladding layer 710, in an exemplary embodiment, is a conventional InP cladding layer having a dopant formed therein. The dopant is typically a p-type dopant such as zinc, however, one having skill in the art understands that other dopants, such as cadmium, beryllium or magnesium, may be used in this capacity.

The upper cladding layer 710 may be formed using a conventional epitaxial process, for example a metalorganic vapor-phase epitaxy, or other similar process. After formation of the upper cladding layer 710, the capping layer 155, the back facet coating 160, the front facet coating 170, the upper contact 180 and the lower contact 190 (all illustrated in FIG. 1) may all be conventionally formed, resulting in a device similar to the completed optoelectronic device 100 illustrated in FIG. 1.

In an exemplary embodiment, lateral definition of the optoelectronic device 200 (e.g., direction into the page) may be accomplished prior to completion thereof. In such an embodiment, an initial upper cladding layer would be grown on the active region 610 and upper confinement layer 630, and then masked and etched. Next, areas outside of the active region 610 would be regrown with a confinement material, such as InP, for optical and electrical confinement thereof. Then, the manufacturing process would continue as described above, by forming the upper cladding layer 710.

Alternatively, a ridge waveguide structure could be formed in conjunction with the optoelectronic device 200. In such an example, and after formation of the capping layer 155, the optoelectronic device 200 could be etched laterally to provide lateral optical confinement for the active region 610. An insulation material would then be deposited on the etched regions of the optoelectronic device 200, providing lateral optical confinement therefor. Then, the upper contact 180 and the lower contact 190 could be formed. While certain embodiments have been illustrated and discussed, other embodiments, many of which have not been discussed, are within the scope of the present invention.

As previously recited, the completed optoelectronic device 100 may operate in a superior manner to many of the prior art devices. For instance, the bandwidth of the grating reflectivity is significantly wider than the cavity mode spacing. This allows multiple cavity modes near the peak reflectivity of the grating to laze simultaneously, and results in a broadened linewidth. The broadened linewidth, in turn, suppresses Stimulated Brillouin Scattering (SBS) effects, an aspect not present in many of the prior art devices. Additionally, the present invention provides a reduced side mode suppression ratio (SMSR). In an exemplary embodiment the SMSR is less than about 10 dB, as compared to about 30 dB in many prior art devices.

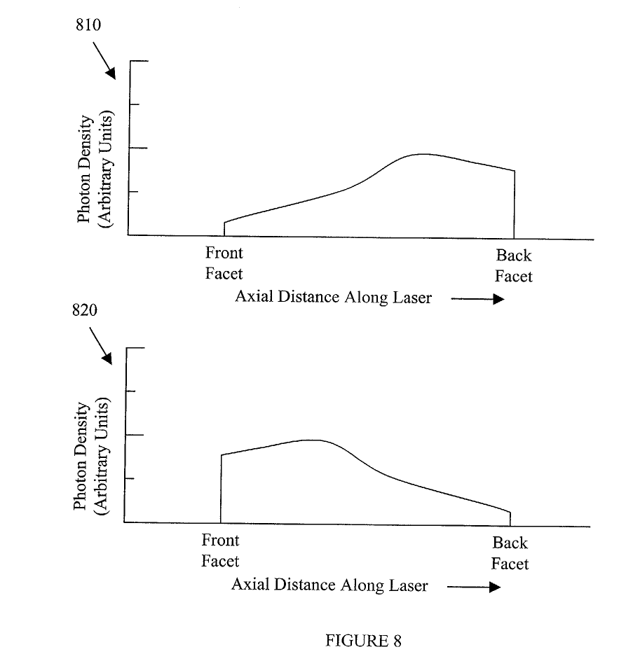

Turning to FIG. 8, illustrated is a graphical representation 810 of a Prior Art laser structure and a graphical representation 820 of the optoelectronic device 100 illustrated in FIG. 1. As illustrated, both graphical representations 810, 820 compare photon density versus axial distance for the various devices. As illustrated in the Prior Art graphical representation 810, the photon density peaks near the back facet. In contrast, and as depicted in the graphical representation 820, the photon density peaks near the front facet in the optoelectronic device 100. Because the photon density peaks near the front facet in the optoelectronic device 100, a substantially increased output power may be obtained.

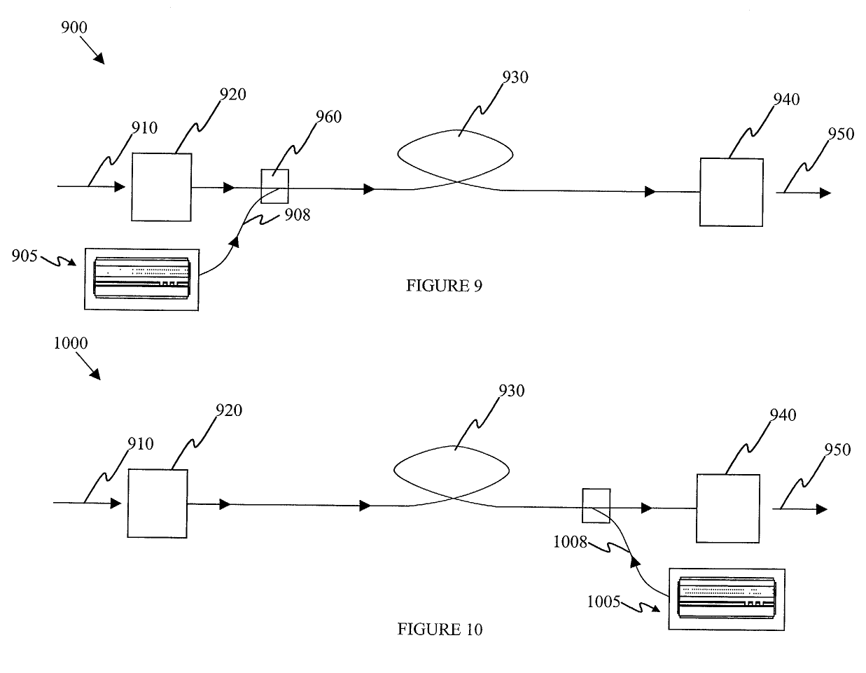

Turning to FIG. 9, illustrated is an optical communication system 900, which may form one environment where an optoelectronic device 905, similar to the optoelectronic device 100 shown in FIG. 1, may be included. The optical communication system 900, in the illustrative embodiment, includes an initial signal 910 entering a source device 920. The source device 920, may comprise a number of different devices, however, in an exemplary embodiment the source device 920 comprises an optical signal source, an erbium doped fiber amplifier (EDFA) or a repeater. The source device 920, receives the initial signal 910, addresses the signal 910 in whatever fashion desired, and sends the signal 910 across an optical fiber 930 to a receiving device 940. The receiving device 940 may also comprise a number of different devices, including a receiver, an EDFA or a repeater. The receiving device 940 receives the information from the optical fiber 930, addresses the information in whatever fashion desired, and sends an ultimate signal 950.

As illustrated in FIG. 9, the completed optoelectronic device 905 may be positioned proximate the source device 920. In such an example, an output signal 908 of the optoelectronic device 905 would co-propagate with the signal 910, and provide amplification therefor. In an exemplary embodiment, an optical combiner 960 could be used to combine the signal 910 and the output signal 908.

Turning briefly to FIG. 10, illustrated is an optical communication system 1000, having a completed optoelectronic device 1005 located proximate the receiving device 940. In such an example, an output signal 1008 of the optoelectronic device 1005 would counter-propagate with the signal 910, and provide amplification therefor. In as much, the optoelectronic devices 905, 1005 may act as amplification sources for an already present signal (e.g., Raman amplification), as compared to a signal sources as used in many of the prior art applications.

The optical communication systems are not limited to the devices previously mentioned. For example, the optical communication systems may further include various other lasers, photodetectors, optical amplifiers, transmitters, and receivers.

Although the present invention has been described in detail, those skilled in the art should understand that they can make various changes, substitutions and alterations herein without departing from the spirit and scope of the invention in its broadest form.

What is claimed is:

1. An optoelectronic device, comprising:
a device body including an active region having a cavity length defined by a back facet and a front facet; and
a diffraction grating optically coupled to the active region and having a grating length of less than about 25 percent of the cavity length.

2. The optoelectronic device as recited in claim 1 wherein the diffraction grating is located proximate the front facet.

3. The optoelectronic device as recited in claim 2 wherein the diffraction grating is offset from the front facet by a distance ranging from about 10 μm to about 40 μm.

4. The optoelectronic device as recited in claim 1 wherein the diffraction grating is located proximate the back facet.

5. The optoelectronic device as recited in claim 4 wherein the diffraction grating is offset from the back facet by a distance ranging from about 10 μm to about 40 μm.

6. The optoelectronic device as recited in claim 1 wherein the grating length is less than about 15 percent of the cavity length.

7. The optoelectronic device as recited in claim 1 wherein the cavity length is greater than about 1.3 mm and the grating length ranges from about 50 μm to about 150 μm.

8. The optoelectronic device as recited in claim 1 further including a high reflection coating on the back facet and an antireflection coating on the front facet, and wherein the grating length multiplied by a grating coupling constant of the diffraction grating, ranges from about 0.06 to about 1.0.

9. The optoelectronic device as recited in claim 1 wherein the diffraction grating includes a first grating layer, a second grating layer and a third grating layer, and the optoelectronic device further includes a spacer layer located over the diffraction grating, and wherein a thickness of the second grating layer and the spacer layer may be altered to adjust a reflectivity of the diffraction grating.

10. A method of manufacturing an optoelectronic device, comprising:
creating a device body including an active region having a cavity length defined by a back facet and a front facet; and
forming a diffraction grating optically coupled to the active region and having a grating length of less than about 25 percent of the cavity length.

11. The method as recited in claim 10 wherein forming includes forming the diffraction grating proximate the front facet between the front and back facet.

12. The method as recited in claim 10 wherein the grating length is less than about 15 percent of the cavity length.

13. The method as recited in claim 10 wherein forming includes forming a diffraction grating having a grating length that ranges from about 50 μm to about 150 μm.

14. The method as recited in claim 10 further including providing a high reflection coating on the back facet and providing an antireflection coating on the front facet, and wherein the grating length multiplied by a grating coupling constant of the diffraction grating, ranges from about 0.06 to about 1.0.

15. The method as recited in claim 10 wherein forming a diffraction grating includes forming a first grating layer, a second grating layer and a third grating layer, and the method further includes placing a spacer layer over the diffraction grating, and wherein a thickness of the second grating layer and the spacer layer may be altered to adjust a reflectivity of the diffraction grating.

16. The method as recited in claim 10 wherein forming a diffraction grating includes forming a diffraction grating having an optical period that is varied along the cavity length.

17. The method as recited in claim 16 wherein forming a diffraction grating having an optical period that is varied along the cavity length includes using a chirped grating or a varying mesa width to form the diffraction grating having the optical period that is varied along the cavity length.

18. An optical communications system, comprising:
an optical device, including;
a device body including an active region having a cavity length defined by a back facet and a front facet; and
a diffraction grating optically coupled to the active region and having a grating length of less than about 25 percent of the cavity length; and
an optical waveguide coupled to the optical device.

19. The optical communications system as recited in claim 18 further including devices coupled to the optoelectronic device that are selected from the group consisting of:
lasers,
photodetectors,
optical combiners,
optical amplifiers,
transmitters, and
receivers.

20. An optoelectronic device, comprising:
a first confinement layer located over an optoelectronic substrate;
an active region located over the first confinement layer, wherein the active region has a cavity length defined by a back facet and a front facet;
a second confinement layer located over the active region; and
a diffraction grating located on the optoelectronic substrate and proximate the first confinement layer, wherein the diffraction grating is optically coupled to the active region and has a grating length of less than about 25 percent of the cavity length.
